(19) United States
(12) Patent Application Publication
(10) Pub. No.: US 2006/0078190 A1
(43) Pub. Date: Apr. 13, 2006

(54) Method and apparatus for inspecting defects

(76) Inventors: Yukihiro Shibata, Fujisawa (JP); Kei Shimura, Mito (JP); Hidetoshi Nishiyama, Fujisawa (JP); Shunji Maeda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/196,396

(22) Filed: Aug. 4, 2005

(30) Foreign Application Priority Data
Sep. 29, 2004 (JP) 2004-283016

(51) Int. Cl. G06K 9/00

(52) U.S. Cl. 382/149

(57) ABSTRACT

In order to detect defects without reducing the inspection speed, even when inspection is made by acquiring a high magnification image, defect inspection method is provided in which a surface of a sample is illuminated, via an illumination optical system, with light emitted by an illumination light source, an image of the sample illuminated with the light is picked up via a detection optical system, and the picked up image of the sample is compared with a previously stored image to detect defects. In illuminating the sample with the light, the area of the sample to be illuminated is varied according to an imaging magnification of the detection optical system.

### BACKGROUND OF THE INVENTION

The present invention relates in general to a method and an apparatus for detecting defects, including particle defects, in micro-patterns that have been formed on a substrate through a thin film process of the type typically used in the fabrication of semiconductor devices and flat panel displays.

The configuration of an illumination apparatus for microscopes is disclosed in JP-A No. 5083/2003. In this apparatus, light emitted by a light source enters a fly-eye lens and forms a group of point sources at an exit end of the lens. When a group of point sources are formed by use of a fly-eye lens, as in the described configuration, at an exit end of the fly-eye lens, the group of point sources (secondary light sources), as a whole, provide a uniformly distributed illuminance. In the apparatus having such a configuration, the light intensity of the whole group of the secondary light sources and the directional distribution of the light emitted from individual point sources are uniform. The group of point sources is disposed at a position that is conjugated with the exit pupil of an object lens, thereby, configuring a Kohler illumination system.

In a conventional technique, a group of point sources (secondary light sources) are formed using a fly-eye lens, and the light intensity of the whole group of secondary light sources and the directional distribution of light emitted from individual point sources are made uniform. Applying a configuration based on this conventional technique to a microscope incorporating a reflected light illumination system causes loss of a certain amount of light due to use of a half-mirror, which is indispensable for a reflected light microscope and which splits the light into two beams, one for an illumination system and the other for a detection system for observing an image of a sample. As to the amount of light that is lost, (a) approximately 50% of the loss is caused along a light path between the light source and the sample (loss on the illumination side) and (b) approximately 50% of the loss is caused along a light path between the sample and the image surface (loss on the detection side).

Therefore, in an inspection apparatus whose optical system includes a reflected light microscope system, light emitted by a light source is once transmitted through a half-mirror and once reflected by the half-mirror along a light path leading from the light source to where the light reflected from the surface of a sample forms an image of the sample on the surface of an image sensor. In this way, a total of 75% of the light emitted from the light source is lost without reaching the image surface (a loss of 75%). Thus, to secure an adequate detection signal level for the image sensor, it is necessary to intensify the light emitted by the light source (increase the amount of light). Consequently, the light source needs to be made larger, with the result that the cost of the apparatus increases.

In the above-described optical system, photons which enter the image sensor that is disposed on the image surface are photoelectrically converted in order to turn light-intensity information into an electrical signal. To improve the throughput of the apparatus, it is necessary to increase the speed of image detection by the image sensor and, thereby, to increase the speed of sample surface scanning by the image sensor. For this purpose, it is necessary to reduce the accumulation time taken by the image sensor. If, for example, in order to double the throughput, the accumulation time for the image sensor is halved, with the image surface illuminance kept constant, the electrical signal output by the image sensor is also halved. If, in order to raise the signal level by two times, the electrical gain is increased by two times, the S/N ratio of the electrical signal is relatively halved. An image detected under this condition has a large noise. To increase the throughput by two times, therefore, it is necessary to increase the image surface illuminance by two times.

In using an inspection apparatus, there are cases in which the magnification of an optical system is changed. For example, when it is desired to perform an inspection with high sensitivity, the optical system magnification is raised and the projection size on a wafer per pixel of the image sensor is reduced. Doing so makes it possible to sample an optical image of a wafer more finely so as to perform higher-sensitivity inspection, though at a lower speed. For inspection processes not strictly requiring, in relative terms, a high sensitivity, there are cases in which the optical system magnification is lowered, with importance being placed on the inspection speed. Hence, the inspection apparatus includes a magnification changing part which enables plural optical system magnifications to be set.

Such a magnification changing part may change the magnification either by making a change in an objective lens system or by making a change in an imaging lens system, without making any change in the objective lens system. In pursuit of a higher resolution, however, objective lens systems use aberration correction in short wavelength ranges and high NAs (numerical apertures), resulting in a higher cost. Therefore, it is more practical to change the magnification, not by changing the objective lens system, but by changing the imaging lens system, which is relatively inexpensive.

In a case in which the magnification can be changed, if the ratio of a low magnification to a high magnification is 1:3, the amount of photons which enter the image sensor with the high magnification selected is 1/9 the amount of photons which enter the image sensor with the low magnification selected. Therefore, if the detection sensitivity of the image sensor is constant, the image surface illuminance required to perform high-magnification inspection cannot be obtained without extending the accumulation time to be used by the image sensor. Therefore, it has been unavoidable to lower the inspection speed when performing high-magnification inspection.

Along with the inspection speed, the inspection sensitivity is also a basic index of performance of an inspection apparatus. It is ideal if all defects of interest are detected by one inspection. Depending on the structure and size of the target defects, detecting all of them requires more than one inspection to be performed.

### SUMMARY OF THE INVENTION

The present invention provides a method and an apparatus for detecting defects without reducing the inspection speed, even when inspection is carried out by the acquisition of a high magnification image.

According to the present invention, plural lens arrays for different illumination areas are disposed in an illumination light path and are selectively used according to the detection field of view. To secure illuminance uniformity even in the presence of various factors, such as light source fluctuations, which destabilize inspection, a holographic diffusion plate defining diffusivity is disposed on the incident side of the lens arrays. Furthermore, to detect target defects, inspection is performed twice while applying different optical conditions, thereby facilitating narrowing down of target defects.

A defect inspection apparatus according to one aspect of the present invention includes an illumination light source; an illumination optical system part, which illuminates a surface of a sample with light emitted by the illumination light source; a detection optical system part, which forms an image of the sample being illuminated, via the illumination optical system part, by the light; an imaging part, which picks up the image of the sample formed by the detection optical system part; and an image processing part, which detects defects by comparing the image picked up by the imaging part of the sample with a previously stored image. In the defect inspection apparatus, the detection optical system part includes an imaging magnification switching section which allows an imaging magnification to be set switchably, and the illumination optical system part includes an illumination area setting section, which changes an area to be illuminated on the surface of the sample according to the imaging magnification set in the imaging magnification switching section.

According to the above-described aspect of the present invention, even when the magnification is changed during imaging, the relative speed of movement between a wafer and a detection optical system can be kept constant or almost constant, thus making it possible to acquire high-magnification images without decreasing the throughput.

These and other objects, features and advantages of the present invention will become apparent from the following more particular description of preferred embodiments of the invention, as illustrated in the accompanying drawings.

### BRIEF DESCRIPTION OF THE DRAWINGS

FIG. 1 is a diagrammatic front elevational view showing an approximate arrangement of an optical visual inspection apparatus according to a first embodiment of the present invention;

FIG. 2(a) is a diagrammatic plan view of an illumination optical system in which the illumination area is variable and in which rod lenses make up a lens array for use when the field of view is large;

FIG. 2(b) is a diagrammatic plan view of an illumination optical system in which the illumination area is variable and in which rod lenses make up a lens array for use when the field of view is small;

FIG. 3(a) is a diagrammatic plan view in the XZ plane of an illumination optical system in which the illumination area is variable and in which cylindrical lenses are used as lens arrays for use when the field of view is large;

FIG. 3(b) is a diagrammatic plan view in the YZ plane of an illumination optical system in which the illumination area is variable and in which cylindrical lenses are used as lens arrays for use when the field of view is large;

FIG. 4(a) is a diagrammatic plan view in the XZ plane of an illumination optical system in which the illumination area is variable and in which cylindrical lenses are used as lens arrays for use when the field of view is small;

FIG. 4(b) is a diagrammatic plan view in the YZ plane of an illumination optical system in which the illumination area is variable and in which cylindrical lenses are used as lens arrays for use when the field of view is small;

FIG. 5(a) is a diagrammatic plan view in the XZ plane of an illumination optical system in which the illumination area is rectangular and variable;

FIG. 5(b) is a diagrammatic plan view in the YZ plane of an illumination optical system in which the illumination area is rectangular and variable;

FIG. 6 is a diagrammatic plan view of an illumination optical system in which the illumination area is variable;

FIG. 7 is a diagrammatic front elevational view showing an approximate arrangement of an optical visual inspection apparatus according to a second embodiment of the present invention;

FIG. 8 is a perspective view showing an approximate arrangement of a polarization adjusting mechanism according to the second embodiment of the present invention;

FIG. 9 is a diagram which shows an image (a) transmitted from an A/D conversion circuit, a previously stored image (b) of an adjacent die, and a difference image (c) between the images (a) and (b);

FIG. 10 is a graph showing an example of defect representations;

FIG. 11 is a diagram illustrating target defect classification;

FIG. 12 is a diagrammatic front elevational view showing an approximate arrangement of an optical visual inspection apparatus according to a third embodiment of the present invention;

FIG. 13(a) is a diagram illustrating target defect classification according to the third embodiment of the present invention;

FIG. 13(b) is a diagram illustrating target defect classification according to the third embodiment of the invention;

FIG. 13(c) is a diagram illustrating target defect classification according to the third embodiment of the invention; and

FIG. 14 is a flowchart of a process for determining optical conditions.

### DESCRIPTION OF THE PREFERRED EMBODIMENTS

Various embodiment of the present invention will be described with reference to the accompanying drawings.

### Embodiment 1

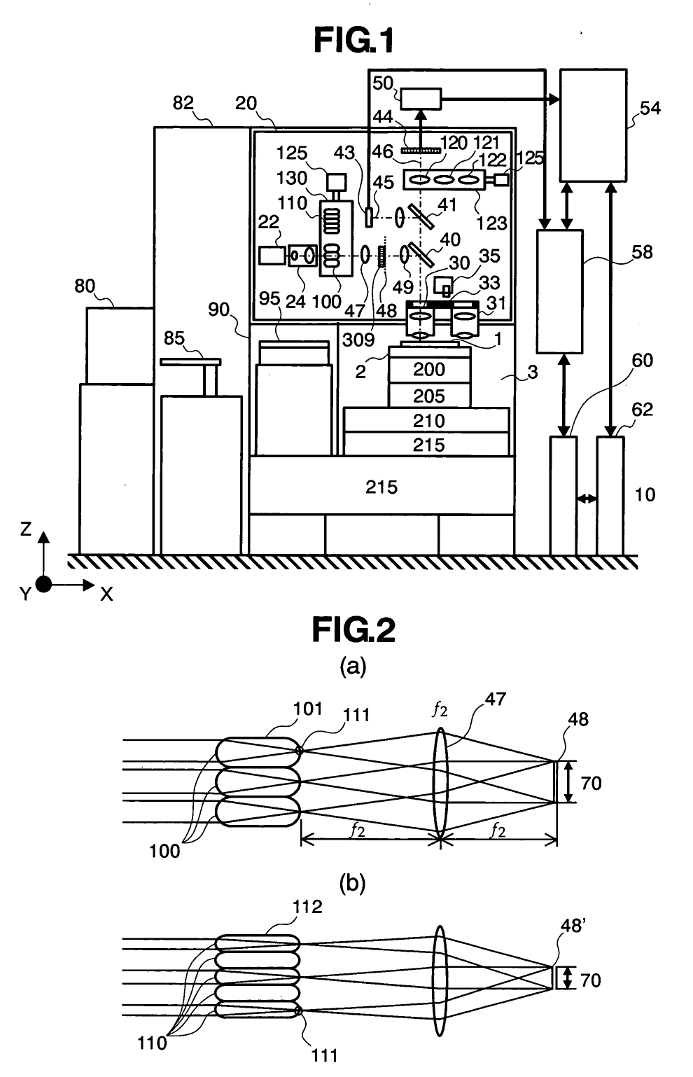

FIG. 1 shows an example in which the present invention is applied to an optical visual inspection apparatus for semiconductor wafers. A wafer to be inspected is placed in a cassette 80. It is transferred to an inspection preparation chamber 90 and is loaded in a wafer notch (orientation flat) detection section 95 by a wafer delivery robot 85. In the notch detection section 95, the wafer orientation is prealigned. The wafer is then transferred to an inspection station 3. At the inspection station 3, the wafer, denoted by the numeral 1, is fixed in position by a chuck 2. The chuck 2 is mounted on a Z-direction stage 200, a θ-direction stage 205, an X-direction stage 210, and a Y-direction stage 215. These stages and an optical system 20, which forms an image of the wafer 1, are mounted on a stone surface plate 215.

A beam of illumination light emitted from a light source 22 of the optical system 20 has its beam diameter expanded by a beam expander 24, and it then enters a lens array 100. The lens array 100 is composed of plural lenses. A point source of light is formed at the rear focal position of each of the plural lenses. Therefore, in the lens array 100, as many point sources of light as the number of lenses composing the lens array 100 are formed. The point sources are collimated by a lens 47, and a surface with a uniform illumination distribution is formed at a position 48 that is conjugated with the wafer 1. The illumination light beam with a uniform illumination distribution formed on the surface that is conjugated with the wafer 1 uniformly illuminates the wafer 1 via a lens 49 and an objective lens 30. An image of the point sources formed in the lens array 100 is projected, via the lenses 47 and 49, on a pupil plane of the objective lens 30. In this way, the wafer 1 is Kohler-illuminated.

The light beam reflected and diffracted by the wafer 1, being illuminated as described above, passes the objective lens 30 again and reaches a beam splitter 40. The light beam transmitted through the beam splitter 40 enters a beam splitter 41, which splits the light beam into two beams, which advance along a focus detection light path 45 and an image detection light path 46, respectively. The light beam transmitted through the beam splitter 41, using an imaging lens 120, forms an image of the wafer 1 on an image sensor 44. The image sensor 44 may be a back-illuminated CCD (charge coupled device) array with high quantum efficiency at short wavelengths (for example, a TDI (time delay integration) sensor composed of parallel one-dimensional CCDs arranged in a multistage configuration). When a detection system uses infinity correction, the magnification of the detection system is determined by the ratio between the focal lengths of the objective lens 30 and the imaging lens 120. When the magnification is lower, the throughput is higher. A high magnification has an advantage. That is, when the magnification is higher, finer defects can be detected and, as a result, the inspection sensitivity improves. Therefore, an inspection apparatus is, required to offer plural magnifications.

The magnification can be changed by changing the focal length of the objective lens 30 or that of the imaging lens 120. The objective lens 30 is composed of plural lens groups. The objective lens 30 is an important component which determines the resolution properties of the optical system, and it is more expensive than the imaging lens 120. To enable short wavelength illumination using ultraviolet wavelengths or shorter wavelengths (for example, illumination using UV (ultraviolet) or DUV (deep ultraviolet) light), aberration correction, which is more difficult than when using visible-range wavelengths, is necessary, so that the lens becomes more expensive. Compared with the objective lens 30, the imaging lens 120 can be fabricated less expensively. Therefore, as a method for changing the magnification of the inspection apparatus, changing the imaging lens 120, rather than the objective lens 30, is more economical. For this reason, in addition to the imaging lens 120 with high-magnification, an intermediate magnification imaging lens 121 and a low magnification imaging lens 122 are provided as well, making up an imaging lens group including plural lenses with different magnifications. A stage 123, on which the group of the imaging lenses are mounted, is driven by a motor 125 to allow an appropriate magnification to be selected depending on an object to be inspected.

In a case where plural imaging lenses making up a lens group are selectively used through switching, assume that the field of view on the wafer 1 measures 1 (criterion value) when the low magnification imaging lens 122 is in use and that the value is ⅓ when the high magnification imaging lens 120 is in use. In this case, the high magnification is three times as high as the low magnification. If the amount of photons entering the image sensor 44 measures 1 when the low magnification imaging lens 122 is in use, the amount of photons entering the image sensor 44 decreases, when the high magnification imaging lens 120 is in use, to 1/9 based on the condition that the illumination intensity distribution on the wafer 1 is uniform. This may cause a problem, when making an inspection using the high magnification imaging lens, in that the image sensor 44 requires a longer accumulation time to secure a required amount of image surface illuminance.

To prevent the above-stated problem, as the field of view on the wafer 1 changes corresponding to the magnification setting, the illumination area is changed without decreasing the amount of light illuminating the wafer 1, and, thereby, the image surface illuminance is kept constant even when the detection magnification changes. This is effected by changing the lens array 100 disposed in the illumination system. In the optical system, when a position in the vicinity of the incident plane of the lens array 100 is optically conjugated with the wafer 1, the size of the incident plane of each of the lenses making up the lens array 100 equals the size of the illuminated area on the wafer 1. Therefore, in a case in which the low magnification imaging lens 122 is used, for example, the field of view on the wafer 1 is relatively large. In such a case, lenses each with a large incident plane are used to make up the lens array 100 so as to allow the illuminated area on the wafer 1 to cover the field of view of the low magnification imaging lens 122.

In a case in which the high magnification lens 120 is used, lenses each with a small incident plane are used to make up the lens array 110 so as to allow the illuminated area on the wafer 1 to cover the field of view of the high magnification imaging lens 120 (⅓ of the field of view of the low magnification imaging lens 122). The illuminated area in this case is 1/9 as large as the illuminated area obtained using the lens array 100, so that the amount of illumination per unit area on the wafer 1 is 9 times as large as the corresponding amount obtained using the lens array 100.

As described above, switching between the lens arrays 100 and 110, according to which one of the high-magnification lens 120 and the low-magnification lens 122 is used, makes it possible to change the illuminated area on the wafer 1 without decreasing the total amount of illumination. In an example of the arrangement for changing the illuminated area, the lens arrays 100 and 110 are mounted on the stage 130; and, depending on the magnification of the imaging lens to be used, an appropriate lens array is set on a light path by driving the stage 130 up and down with motor 125 (in FIG. 1, the lens array corresponding to the intermediate-magnification imaging lens 121 is not illustrated). Such an arrangement reduces the illumination loss when the high-magnification imaging lens is used. Therefore, it is possible, for each of the imaging lenses with different magnifications, to secure required image surface illuminance using a light source with a relatively low output.

The light source may be either a laser or a lamp. When using a laser, its emission wavelength may be 355 nm, 266 nm, 199 nm, or 157 nm. When implementing multiwavelength illumination, lamps are useful. Such lamps as Hg lamps, Hg—Xe lamps, and Xe lamps may be used. The illumination wavelengths may range anywhere from the visible range to the DUV and VUV (vacuum ultraviolet) ranges. Even though, in the arrangement shown in FIG. 1, the objective lens 30 is assumed to be used in an atmospheric environment or in a vacuum environment, the present invention is also applicable to cases in which an immersion objective lens is used to image the wafer 1 in a state in which a liquid is filled between the objective lens 30 and the wafer 1.

In a case in which the light source 22 is replaced by a visible light source, the objective lens 31, whose aberration has been corrected based on the visible light, is used. The objective lenses 30 and 31 are mounted on a turntable 33 which is driven by a motor 35 to exchange the positions of the two objective lenses.

The light reflected by the beam splitter 41 without being transmitted enters a focus detection sensor 43 as a light beam for detecting a focus difference between the wafer 1 and the objective lens 30. In an example of the focus detection method, a stripe pattern 309 is placed in the position 48 that is conjugated with the wafer on the illumination path, the stripe pattern 309 is projected on the wafer 1, and the image of the stripe pattern 309 reflected by the wafer 1 is detected by the focus detection sensor 43. In this arrangement, it is preferable that the image of the stripe pattern 309 be spatially separated from the field of view detected by the image sensor 44. The contrast of the image of the stripe pattern 309 is calculated at a mechanical controller 58, and, if defocusing is detected, focusing is corrected by driving the Z-direction stage 200. In this way, focusing of an optical image formed on the image sensor 44 can be adjusted. It is desired that the light beam used for focus detection either be equivalent in wavelength to the image formed on the image sensor 44 or have undergone aberration correction using the objective lens 30.

The image detected by the image sensor 44 is converted, at an A/D conversion circuit 50, into a digital image, and it is then transferred to an image processing section 54. In the image processing section 54, as shown in FIG. 9, the image (a) transferred from the A/D conversion circuit 50 is compared with an image (b), which is picked up and stored in advance, of coordinates of an adjacent die (or cell) on which a pattern identical in design to the image transferred from the A/D conversion circuit 50 is formed, and, thereby, a difference image (c) is obtained. The difference image thus obtained is binarized based on a predetermined threshold value to determine defects.

In a case in which the image sensor 44 is of a linear image sensor type (a TDI sensor included), the wafer 1 is scanned at a constant speed and an image is detected in synchronization with the scanning of the wafer 1. These stages and the wafer delivery robot 85 are controlled by the mechanical controller 58. The mechanical controller 58 controls the mechanical system according to orders received from an operating controller 60, which controls the whole apparatus. When defects are detected in the image processing section 54, relevant defect information is stored in a data server 62. The defect information to be stored includes information on defective coordinates, defective size, defective image, and defect classification. The defect information can be displayed and searched for using the operating controller 60.

Next, with reference to FIGS. 2(a) and 2(b), how the illumination area is changed will be described. FIG. 2(a) shows an example of the lens array 100 for use when the field of view on the wafer 1 is large (when the illumination area is large). Parallel light from a light source enters the lens array 100 (also called a fly eye lens, a rod lens array, or a homogenizer) composed of an array of rod lenses 101. Compared with a case, to be described later, in which the field of view is small, the incident plane of each of each rod lenses 101 is large. The parallel light that enters each of the rod lenses 101 converges at a point 111 at the exit end of the rod lens. When the light entering each of the rod lenses 101 has a divergence (NA: numerical aperture), plural point sources are formed at the exit end of each of the rod lenses 101 with the number of point sources being dependent on the incident angle of the light. The lens 47, which is disposed between the exit ends of the rod lenses 101 and the wafer 1, serves to uniformly illuminate the plane 48 that is conjugated with the wafer. An illumination area 70 is as large as required according to the magnification of the projection from the plane 48 that is conjugated with the wafer to the wafer surface. The exit end of the lens array 100 is conjugated with the pupil position of the objective lens 30. In this arrangement, the wafer 1 is Kohler-illuminated.

FIG. 2(b) shows an example in which the detection system is set to a high magnification. Compared with the example shown in FIG. 2(a), in which the field of view is large, the incident plane of each of the rod lenses 112 making up the lens array 110 is small. The number of the rod lenses 112 is therefore larger than the number of the rod lenses 101 used when the illumination area is large, as shown in FIG. 2(a). On the plane 70 that is conjugated with the wafer, the illumination area is smaller in the case shown in FIG. 2(b), corresponding to the size of the incident plane of each of the rod lenses 112, causing thereby the illuminated area on the wafer to be also smaller. On the wafer 1, the integrated value of illuminance (total amount of light) over the illuminated area as a whole is the same between the example, as shown in FIG. 2(a), in which the illumination area is large, and the example, as shown in FIG. 2(b), in which the illumination area is small, but the amount of light per unit area is larger in the example shown in FIG. 2(b), in which the illumination area is small.

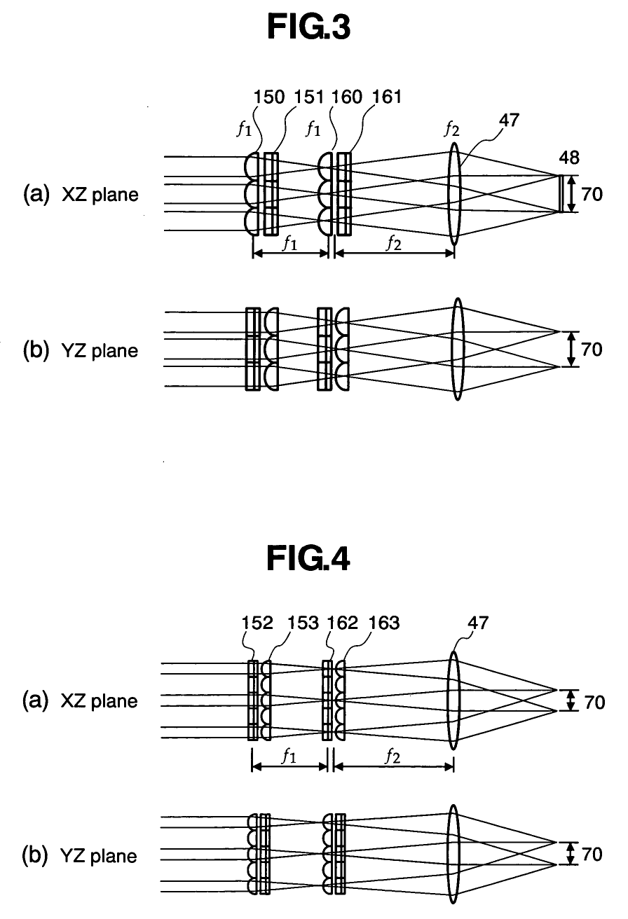

FIGS. 3(a) and 3(b) show an example in which the lens array 100 is composed of cylindrical lens arrays that have been adopted for a large illumination area. FIG. 3(a) shows the lens arrays in the XZ plane in FIG. 1. A cylindrical lens array 150, which is disposed in a first stage, is composed of arrayed lenses, each having a curvature in the XZ plane. This lens array has no curvature in the YZ plane, as shown in FIG. 3(b). A cylindrical lens array 151, which is disposed in a second stage, has no curvature in the XZ plane, but it has a curvature in the YZ, plane as shown in FIG. 3(b). Cylindrical lens arrays 160 and 161 that are disposed in third and fourth stages, respectively, serve as field lenses. The cylindrical lens array 160, which is disposed in the third stage, is composed of arrayed field lenses corresponding to the lenses making up the cylindrical lens array 150 that is disposed in the first stage, respectively. Similarly, the cylindrical lens array 161, which is disposed in the fourth stage, is composed of arrayed field lenses corresponding to the lenses making up the cylindrical lens array 151 that is disposed in the second stage, respectively. On the plane 70 that is conjugated with the wafer, as formed by these lens arrays, the illuminance is uniform similar to that shown in FIGS. 2(a) and 2(b).

It is preferable that point source images formed on the cylindrical lens arrays 160 and 161, serving as field lenses, are projected on the pupil position of the objective lens 30, causing the wafer 1 to be Kohler-illuminated. When it is assumed that the lens array 150 disposed in the first stage, the lens array 160 disposed in the third stage, and the lens 47 have focal lengths of f1, f1, and f2, respectively, it is desirable that the distance between the principal points of the first stage lens array and the third stage lens array, the distance between the principal points of the third stage lens array 160 and the lens 47, and the distance between the lens 47 and the plane 48 that is conjugated with the wafer are f1, f2, and f2, respectively. Depending on the optical system configuration, however, the third stage and the fourth stage cylindrical lens arrays 160 and 161, serving as field lenses, may be omitted. This also applies to the arrangements shown in the subsequent drawings (particularly so in cases in which parallel light enters the first stage cylindrical lens array 150).

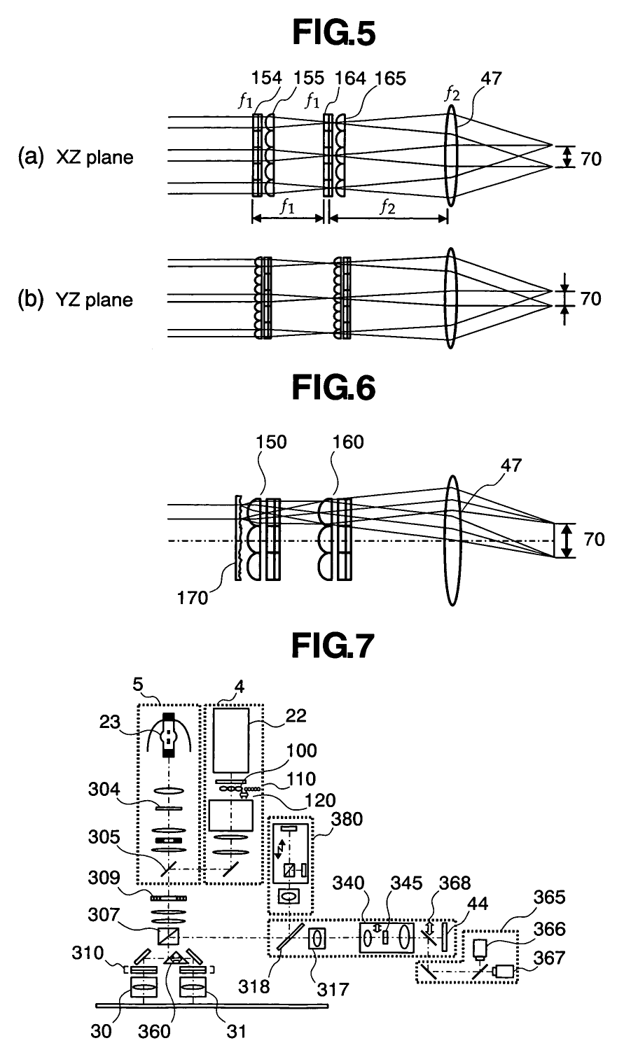

FIGS. 4(a) and 4(b) correspond to FIGS. 3(a) and 3(b), with the illumination area being reduced in the arrangement shown in FIGS. 4(a) and 4(b). In the arrangement shown in FIGS. 4(a) and 4(b), the field of view is narrowed to provide for high-magnification inspection. In this arrangement, basically in the same manner as shown in FIG. 2(b), the incident end of each lens making up each of the first stage to the fourth stage lens arrays is made small. By doing so, the illumination area on the plane 70 that is conjugated with the wafer can be made smaller, and the amount of light per unit area can be made larger than that in the arrangement shown in FIGS. 3(a) and 3(b). The arrangement shown in FIG. 4(b) requires that an effective NA of the light entering the plane conjugated with the wafer is such as to at least allow the incident light to reach the wafer surface. FIGS. 5(a) and 5(b) show how to make an illumination area rectangular. The arrangement is intended, when each CCD detector plane included in the image sensor 44 is rectangular, to improve the illumination efficiency by making the illumination area correspondingly rectangular. In this example, the lens array 100 is composed of a cylindrical lens array. FIG. 5(a) shows an arrangement in the XZ plane. FIG. 5(b) shows an arrangement in the YZ plane. The longitudinal direction of the light receiving section of the image sensor 44 corresponds to FIG. 5(a). The dimension, in a direction corresponding to the longitudinal direction of the light receiving section of the image sensor 44, of each cylindrical lens making up each of the cylindrical lens arrays 154, 155, 164, and 165, is made larger than the dimension in the YZ plane, shown in FIG. 5(b), of each cylindrical lens. By doing so, the illumination area on the plane 70 that is conjugated with the wafer becomes longer in the X direction, as shown in FIG. 5(a), than in the Y direction, shown in as FIG. 5(b). Thus, the illuminated area on the wafer 1 can be made rectangular corresponding to the rectangular field of view of the image sensor 44.

FIG. 6 shows an arrangement in which a diffusion plate 170 is disposed between the cylindrical array 150 and the light source. In a case in which light from a light source is highly directional resulting in parallel incident light, disposing the diffusion plate 170 in front of the cylindrical array 150 makes it possible to make the incident light rays enter the cylindrical lens 150 at an enlarged incident angle. Depending on the incident angle, plural point sources are formed at the rear focal position (in the vicinity of the principal point of the cylindrical lens array 160 that serves as a field lens) of the cylindrical lens array 150. The plural point sources (group of point sources) formed by a pair of the cylindrical lens arrays 150 and 160 uniformly illuminate, via the lens 47, the plane 48 that is conjugated with the wafer. In this way, even in a case where the light source is a laser, it is possible to uniformly illuminate the plane 48 that is conjugated with the wafer without being affected by the pointing stability of the laser, variations in the laser emergence angle or variations in the intrabeam intensity distribution. Thus, illumination of the wafer 1 can be made uniform and stable timewise and spacewise.

The arrangements, as described above, even when the magnification is changed during imaging, enable the relative speed of movement between a wafer and a detection optical system to be kept constant or almost constant, thus making it possible to acquire a high-magnification image without decreasing the throughput.

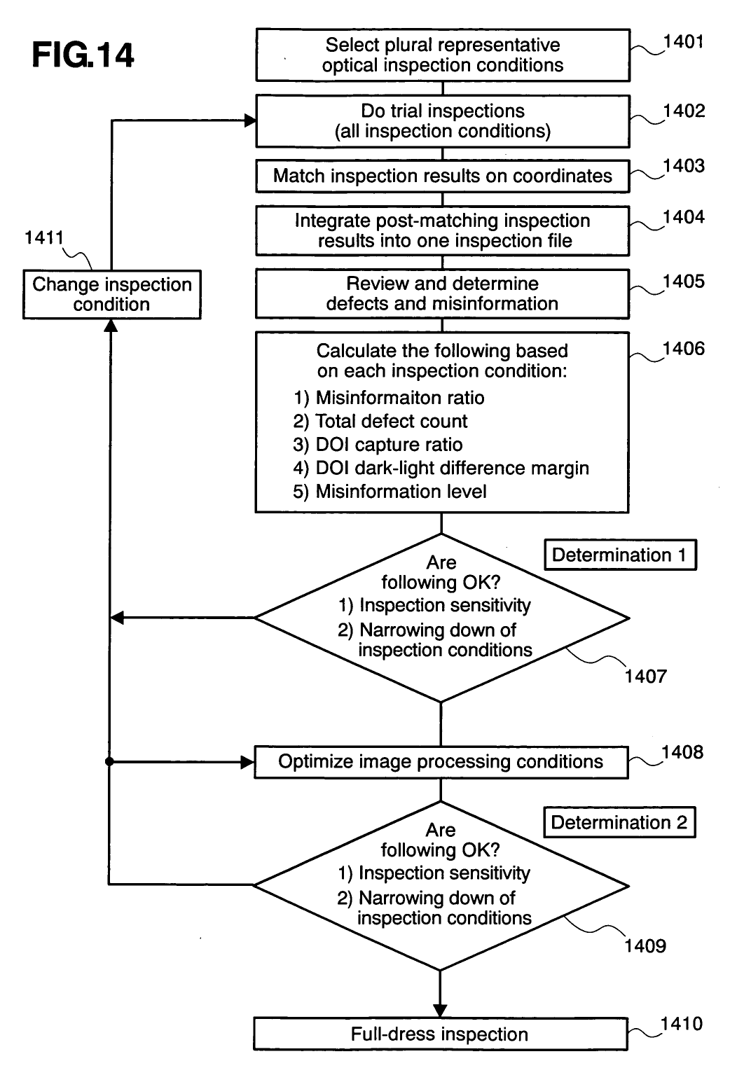

FIG. 14 is a flowchart showing a procedure for finding an optimum one of many optical conditions. First, in the procedure, plural representative optical inspection conditions are selected (1401). Next, trial inspections are carried out based on the selected conditions (1402). Plural inspection results are subjected to matching on coordinates (1403). The inspection results having been subjected to matching on coordinates are integrated into an inspection file (inspection results) (1404). Defects recorded in the integrated inspection file are reviewed to determine real defects and misinformation (1405). Based on the review results, defects detected according to each of the inspection conditions are classified (1406).

Items to be determined by the classification include, for example, (a) the misinformation ratio, (b) the total defect count (excluding misinformation), (c) the DOI (defects of interest) capture ratio, (d) the DOI dark-light difference margin (inspection margin), and (e) the misinformation ratio/misinformation count. Based on the classification results, whether any inspection condition has resulted in a desired inspection sensitivity is determined (determination 1) (1407). If any inspection condition is determined to have resulted in a desired inspection sensitivity, the image processing conditions are optimized in the next step (1408). At this stage, plural optical inspection conditions may be considered eligible. After image processing conditions are optimized, inspection results after optimization of image processing conditions are obtained by performing inspection again, either entirely or using images of defects detected and stored in the previous inspection. Based on the inspection results obtained after optimization of image processing conditions, whether a desired inspection sensitivity has been obtained or not is determined (determination 2) (1409). When the desired inspection sensitivity is determined to have been obtained, the optical inspection condition is finalized and full-dress inspection is performed (1410). In a case in which, according to the determination 1, a desired inspection sensitivity is determined not to have been obtained, the optical inspection conditions are changed and trial inspections are performed again. In a case in which, according to the determination 2, a desired inspection sensitivity is determined not to have been obtained, the image processing conditions or the optical conditions are changed (1411) so as to obtain a desired inspection sensitivity.

In the foregoing, high-efficiency illumination of an optical system, high-efficiency detection of DOIs, and high-efficiency setting of optical conditions have been described. These features can be combined easily, so that any combination of these features is included within the scope of the invention.

### Embodiment 2

FIG. 7 shows an optical system arrangement including a lamp illumination system 5 and a laser illumination system 4 according to a second embodiment of the present invention. Those parts which are common to parts in the arrangement shown in FIG. 1 are denoted by the same reference numerals. A laser beam emitted by a laser 22 is transmitted through the lens array 100 so as to be guided to a light path of the lamp illumination system 5. At a dichroic mirror 305, the laser beam becomes coaxial with the lamp illumination system. Subsequently, light transmitted through a PBS (polarizing beam splitter) illuminates the wafer 1. The laser beam with a wavelength of, for example, 266 nm in the DUV range is combined with UV light (with a wavelength of, for example, 365 nm) from a lamp so as to illuminate the wafer 1.

Light led by a light path switching mirror 360 to a path toward the objective lens 30 (aberration corrected in the DUV/UV range) Kohler-illuminates the wafer 1, and light reflected and diffracted by the wafer 1 is reflected by the PBS so as to be led to a detection light path. Light transmitted through a partial mirror 318 disposed in the detection light path is led toward the image sensor 44 that acquires an image for use in a comparison check. A lens system 340 for forming a position that is conjugated with the pupil position of the objective lens 30 is disposed partway along the detection light path. A position conjugated with the pupil is formed in the lens system 340, and a spatial filter 345 is disposed at the conjugated position, so as to reduce a specific frequency component.

Light reflected by the partial mirror 318 enters a focus detection system 380, which detects a difference in focal position between the surface of the wafer 1 and the objective lens 30. In the focus detection system 380, focus detection is performed as in the first embodiment. When, for example, it is desired to perform inspection using UV light only or UV light combined with visible light for illumination, the light path can be switched toward the objective lens 31 (aberration corrected, for example, for illumination by UV light and visible light combined) using the light path switching mirror 360. Thus, either of the objective lenses 30 and 31 can be selected for use in an inspection depending on the desired inspection wavelength range. When a review camera 367 and an alignment camera 365 are used, a light path switching mirror 368 is disposed in the light path.

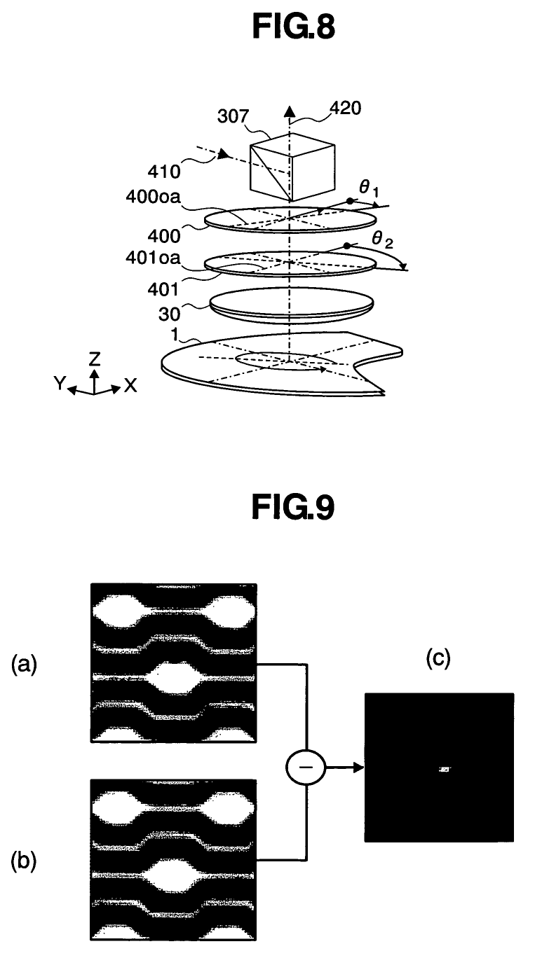

The present embodiment uses an arrangement in which a wavelength plate 310 controls the polarization of light to illuminate the wafer 1, thereby making it possible to select an optical condition which brings about the highest possible inspection sensitivity. FIG. 8 shows an arrangement for controlling the polarization of light. Of the illumination light that enters a PBS 307, an s-polarized light component is reflected so as to become illumination light. The light reflected by the PBS 307 rotates a crystal axis 400oa of a one-half wavelength plate 400 and a crystal axis 401oa of a quarter wavelength plate 401, and it illuminates the wafer 1 as polarized light with optional ellipticity, optional ellipse orientation, and an optional rotational direction. The zero order light that is specularly reflected by a flat portion of the wafer 1 almost unchangedly maintains the polarized state of illumination light, but light scattered by a pattern formed on the wafer 1 and high-order diffracted light assumes a state different (both in amplitude and in phase difference) from the state of the polarized light. Therefore, by controlling the ellipticity and orientation of the illumination light and the rotational direction of polarization, the rate of transmission through the PBS can be adjusted for the zero order light that is specularly reflected by the wafer 1 and first order diffracted light. A p-polarized component transmitted through the PBS reaches, as detection light, the image sensor 44.

FIG. 9 shows an algorithm for detection extraction. The wafer 1 is imaged in an inspection apparatus arranged as shown in FIG. 7, and an image of the coordinates, on which a pattern identical in design to the pattern on the wafer 1 is formed, is detected. For example, the picked-up image of the wafer 1 is compared with an image, that has been picked up and stored in advance, of an adjacent die to obtain a difference image. The difference image thus obtained is binarized based on a predetermined threshold value to determine defects.

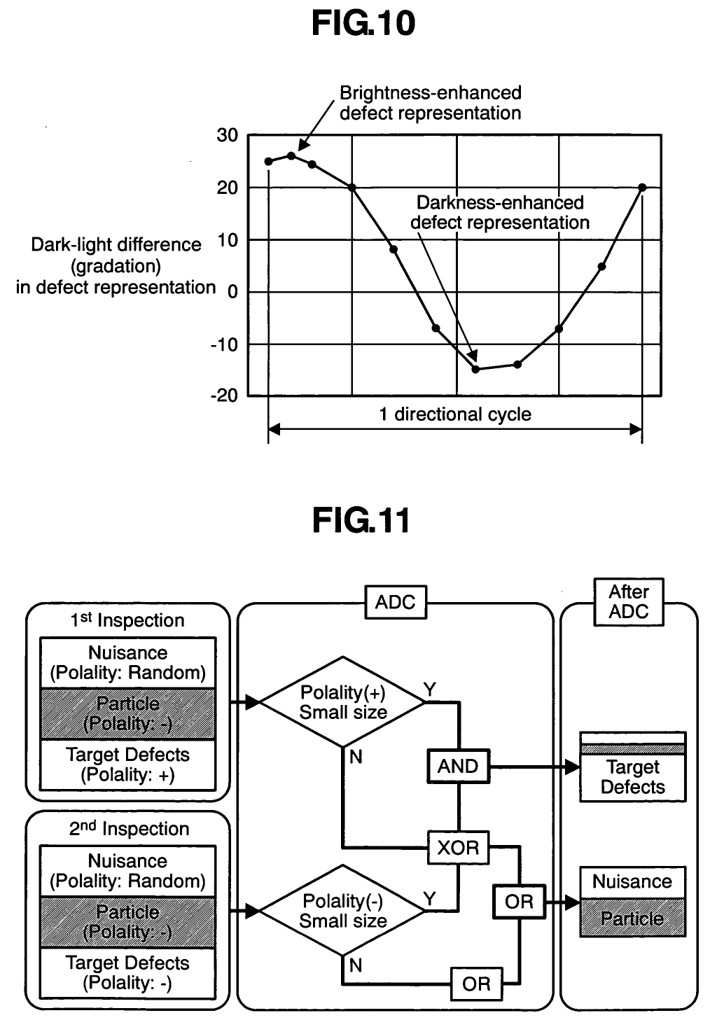

FIG. 10 shows a dark-light difference curve concerning a defect plotted, using the arrangement shown in FIG. 8, with the ellipticity fixed at a predetermined value, by varying the direction of polarization of the illumination light through a period of one cycle, in terms of pattern enhancement. There are conditions which cause a defect to be represented with enhanced brightness and which cause a defect to be represented with enhanced darkness. For example, a pair of such different conditions may be used to determine defects. As shown in FIG. 11, the polarity of a difference image of target defects is positive according to the results of the first inspection. According to the results of the second inspection, on the other hand, the polarity of a difference image of target defects is negative. In the case of a defect like a foreign particle with low reflectance, the polarity of a difference image is highly likely to be negative in both the first inspection and the second inspection. For a non-target defect, such as line edge roughness, a reversal of polarity from positive to negative between the first inspection and the second inspection is not likely to occur. A defect for which the polarity has changed from positive to negative between the first inspection and the second inspection is very likely to be a target defect.

### Embodiment 3

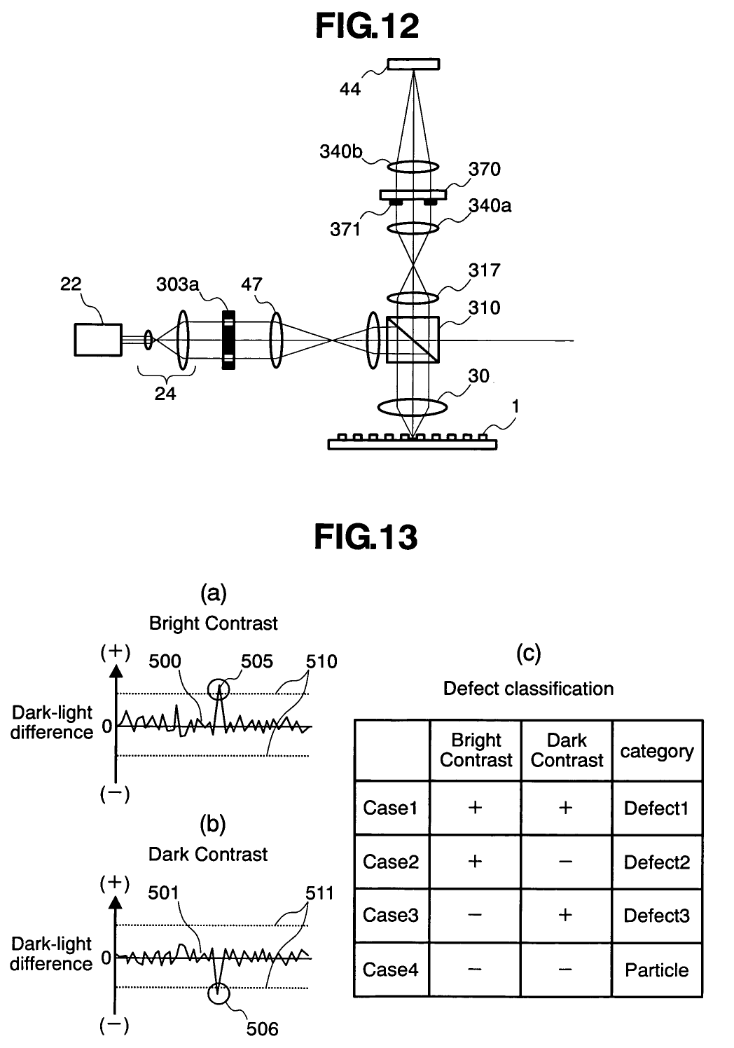

FIG. 12 shows an optical system arrangement including a spatial filter. The parts common to corresponding parts in the arrangement shown in FIG. 1 are denoted by the same reference numerals. A spatial filter 370 is disposed at a position that is conjugated with the pupil of the objective lens 30. As shown at 303a, annular illumination is used, so that zero order light annularly forms an image at the position that is conjugated with the pupil of the objective lens 30. Where the zero order light gathers, a film (optically absorptive and reflective) for suppressing the transmittance of the zero order light is disposed. It is also possible to make a pattern appear differently by providing the zero order light with a phase difference. Depending on a target defect, a bright contrast appears when a quarter wavelength phase-difference film is used and a dark contrast appears when a three-quarter wavelength phase-difference film is used.

FIG. 13(a) shows a waveform obtained by detecting a difference image using an image detected by applying an optical condition for showing bright contrast. A dark-light difference waveform is denoted by the reference number 500, and a dark-light difference threshold value for determining defects is denoted by the reference number 510 (the threshold value is an absolute value). In the present example, when an absolute value of a dark-light difference exceeds the threshold value 510, it is determined that the dark-light difference represent a defect. When the optical condition for showing a bright contrast is applied, the dark-light difference of a defect 505 exceeds the threshold value on the positive side. When the optical condition for showing a dark contrast is applied, a dark-light difference 506 of the same defect as the defect 505 shown in FIG. 13(a) has a negative polarity, as shown in FIG. 13(b), in which the reference number 501 represents a detected dark-light waveform and the reference number 511 represents a threshold value. Performing inspections based on both conditions and comparing the polarities of detected defects makes it possible to optically classify the defects, as shown in FIG. 13 (c).

In the way described above, plural defects can be classified into different categories, such as defect 1, defect 2, defect 3, and foreign particles. What types of defects fall within the defect 1 to defect 3 categories, respectively, is to be grasped in advance through trial inspections and reviews. The user can then predict into which defect category the defects to be reviewed are likely to be classified. In this way, it becomes possible to improve the review efficiency and the defect capture ratio.

The present invention may be embodied in other specific forms without departing from the spirit or essential characteristics thereof. The present embodiment, therefore, is to be considered in all respects as illustrative and not restrictive, the scope of the invention being indicated by the appended claims, rather than by the foregoing description, and all changes which come within the meaning and range of equivalency of the claims are therefore intended to be embraced therein.

1. A defect inspection method, comprising:
illuminating a surface of a sample, via an illumination optical system, with light emitted from an illumination light source,
picking up, via a detection optical system, an image of the sample illuminated with the light, and
detecting defects by comparing the picked-up image of the sample with a previously stored image; wherein, in illuminating the surface of a sample, an area illuminated, in the illumination optical system, with the light of the surface of the sample is varied according to an imaging magnification of the detection optical system.

2. The defect inspection method according to claim 1, wherein, in illuminating the surface of a sample, even when the area illuminated of the surface of the sample is varied, a total amount of light illuminating the area is kept approximately constant.

3. The defect inspection method according to claim 1, wherein, in illuminating the surface of a sample, the illumination light is light in the ultraviolet range.

4. The defect inspection method according to claim 1, wherein, in illuminating the surface of a sample, the illumination light is polarized light.

5. The defect inspection method according to claim 1, further comprising classifying the detected defects.

6. A defect inspection method, comprising:
illuminating a surface of a sample traveling at a constant speed in a direction with illumination light,
picking up an image of the sample illuminated with the illumination light, and
detecting defects by comparing the picked-up image with a previously stored image; wherein, in picking up an image of the sample, the amount of light per unit area of the illumination light illuminating the surface of the sample is varied according to a magnification of the image to be picked up of the sample and, by doing so, the travel speed of the sample traveling in a direction is kept constant regardless of the magnification of the image to be picked up of the sample.

7. The defect inspection method according to claim 6, wherein, in illuminating the surface of a sample, the illumination light is light in the ultraviolet range.

8. The defect inspection method according to claim 6, wherein, in illuminating the surface of a sample, the illumination light is polarized light.

9. The defect inspection method according to claim 6, further comprising classifying the detected defects.

10. A defect inspection apparatus, comprising:
an illumination light source,
an illumination optical system part which illuminates a surface of a sample with light emitted by the illumination light source,
a detection optical system part which forms an image of the sample illuminated, via the illumination optical system part, by the light,
an imaging part which picks up the image of the sample formed by the detection optical system part, and
an image processing part which detects defects by comparing the image picked up by the imaging part of the sample with a previously stored image; wherein:
the detection optical system part comprises an imaging magnification switching section which allows an imaging magnification to be set switchably, and
the illumination optical system part comprises an illumination area setting section which changes an area to be illuminated of the surface of the sample according to the imaging magnification set in the imaging magnification switching section.

11. The defect inspection apparatus according to claim 10, wherein the illumination area setting section keeps a total amount of light illuminating the illumination area approximately constant even when the illumination area of the surface of the sample is changed.

12. The defect inspection apparatus according to claim 10, wherein the imaging magnification switching section comprises a plurality of lens sets with different magnifications, selects one with a desired magnification out of the plurality of the lens sets, and sets the selected lens set in a light path of the detection optical system part.

13. The defect inspection apparatus according to claim 10, wherein the illumination area setting section equips a plurality of lens arrays, each of the lens arrays comprising a plurality of arrayed lenses.

14. The defect inspection apparatus according to claim 10, wherein the imaging magnification switching section comprises a plurality of lens sets with different magnifications and the illumination light amount switching section comprises as many lens arrays as the plurality of the lens sets with different magnifications.

15. The defect inspection apparatus according to claim 10, wherein the light source emits light in the ultraviolet range.

16. The defect inspection apparatus according to claim 10, wherein the illumination light with which the illumination optical system part illuminates the sample is polarized light.

17. A defect inspection apparatus, comprising:
a table part which can travel, carrying a sample set thereon, at least in one direction,
a light source,
an illumination optical system part which illuminates, with illumination light emitted by the light source, a surface of a sample set on the table part,
a detection optical system part which forms an image of the sample illuminated, via the illumination optical system part, by the illumination light,
an imaging part which picks up the image of the sample formed by the detection optical system part, and
an image processing part which detects defects by comparing the image picked up by the imaging part of the sample with a previously stored image; wherein:
the detection optical system part comprises an imaging magnification switching section which allows an imaging magnification to be set switchably, and
the illumination optical system part comprises an illumination light amount switching section which changes, according to the imaging magnification set in the imaging magnification switching section, an amount of light per unit area illuminating the surface of the sample.

18. The defect inspection apparatus according to claim 17, wherein the imaging magnification switching section comprises a plurality of lens sets with different magnifications, selects one with a desired magnification out of the plurality of the lens sets, and sets the selected lens set in a light path of the detection optical system part.

19. The defect inspection apparatus according to claim 17, wherein the illumination light amount switching section comprises a plurality of lens arrays, each comprising a plurality of arrayed lenses.

20. The defect inspection apparatus according to claim 17, wherein the imaging magnification switching section comprises a plurality of lens sets with different magnifications and the illumination light amount switching section comprises as many lens arrays as the plurality of the lens sets with different magnifications.

21. The defect inspection apparatus according to claim 17, wherein the light source emits light in the ultraviolet range.

22. The defect inspection apparatus according to claim 17, wherein the illumination light with which the illumination optical system part illuminates the sample is polarized light.
